(19) United States
(12) Patent Application Publication
(10) Pub. No.: US 2025/0322826 A1
(43) Pub. Date: Oct. 16, 2025

(54) LABELING METHOD FOR UTTERED VOICE AND APPARATUS FOR IMPLEMENTING THE SAME

(71) Applicant: POSICUBE CO., LTD., Seoul (KR)

(72) Inventor: Sung Jo OH, Suwon-si Gyeonggi-do (KR)

(73) Assignee: POSICUBE CO., LTD., Seoul (KR)

(21) Appl. No.: 19/247,377

(22) Filed: Jun. 24, 2025

Related U.S. Application Data
(63) Continuation of application No. PCT/KR2023/018151, filed on Nov. 13, 2023.

(30) Foreign Application Priority Data
Dec. 28, 2022 (KR) 10-2022-0186565

(51) Int. Cl. G10L 15/18; G10L 15/06; G10L 15/22; G10L 15/30

(52) U.S. Cl. CPC G10L 15/1815; G10L 15/063; G10L 15/22; G10L 15/30; G10L 2015/227

(57) ABSTRACT

A labeling method for an uttered voice, performed by a computing system, comprises receiving a first uttered voice from a user terminal, acquiring a first uttered text by converting the first uttered voice into text, extracting a named entity included in the first uttered text by performing Named Entity Recognition (NER) on the first uttered text, acquiring, from a call agent terminal connected via a voice communication session with the user terminal, a second uttered voice including a pronunciation of a corrected named entity corresponding to the extracted named entity, and labeling the corrected named entity in the second uttered voice.

### CROSS-REFERENCE TO RELATED APPLICATIONS

The present application is a continuation of International Patent Application No. PCT/KR2023/018151 filed on Nov. 13, 2023, which is based upon and claims the benefit of priority to Korean Patent Application No. 10-2022-0186565 filed on Dec. 28, 2022. The disclosures of the above-listed applications are hereby incorporated by reference herein in their entirety.

### TECHNICAL FIELD

The present disclosure relates to a labeling method for an uttered voice and an apparatus for implementing the same, and more particularly, to a labeling method for an uttered voice performed on a customer's uttered voice during a consultation call between the customer and a call agent, and an apparatus for implementing the same.

### BACKGROUND ART

A real-time Speech-to-Text (STT) service is basically a service that converts the utterances of speakers (callers/callees) into text in real time using STT/ASR and the like. To implement a real-time STT service, technologies such as separation of voice channels by speaker and streaming for real-time STT processing are required, and in addition, technologies such as extracting the start and end points of an utterance using voice activity detection (VAD) are also needed.

In order to maintain the quality of a real-time STT service at or above a certain level, various training models (acoustic models/language models) for STT tailored to the service domain must be continuously modified and trained through machine learning.

However, in providing such a real-time STT service, the recognition rate for proper nouns or entities in a speaker's utterance is relatively low.

In general, universal acoustic models and language models for STT are trained over at least hundreds or thousands of hours to enhance performance, but training on proper nouns or entities is not conducted extensively because, when a universal STT model is applied to proper nouns or entities, conflicts may arise with other commonly used proper nouns that have similar pronunciations.

For example, in the financial sector, when the term “daebugye” (loan account) is processed by a universal STT model, it may be erroneously interpreted not with the intended meaning of a loan, but as “Daebudo” (a place name) or “pebuge” (on Facebook), which are more commonly used and similarly pronounced terms.

Especially in customer service or call centers, proper nouns specific to the industry are frequently used. For example, in the case of e-commerce, the dialogue with a call agent often includes the proper names of products purchased or to be purchased, addresses, customer names, and the like. In the case of finance, words such as payment, remittance, and amount are often included in the dialogue. As such, there are many proper nouns frequently used by field, and such proper nouns are rarely compatible with or shared across different fields.

Therefore, even with extensive training using a universal STT model, there are limitations in applying proper nouns or entities that are specialized by field. Furthermore, in an environment where new products are continuously introduced and new buzzwords emerge with the changing times, it is not easy to quickly train on a multitude of newly used proper nouns. Also, since real-time STT services mostly rely on supervised learning, a significant amount of time, labor, cost, and effort is required to refine and tag data necessary for training.

Accordingly, in providing real-time STT services, there is a need for a technology capable of extracting, with high recognition accuracy, proper nouns or entities from a customer's utterance during a consultation call between the customer and a call agent. In addition, for generating training data for STT models specialized by field, a process of labeling the proper nouns or entities extracted from the customer's utterance is required.

### DISCLOSURE

### Technical Problems

One technical problem to be solved by the present disclosure is to provide a labeling method for an uttered voice, capable of automatically performing labeling of training data for supervised learning of an STT model from a customer's utterance in the context of providing a real-time STT service for the content of a call between the customer and a call agent, and an apparatus for implementing the same.

Another technical problem to be solved by the present disclosure is to provide a labeling method for an uttered voice, capable of securing a large amount of high-quality training data for training an STT model specialized by field by labeling named entities extracted from a customer's utterance and thereby improving the accuracy of the STT model in the context of providing a real-time STT service, and an apparatus for implementing the same.

Yet another technical problem to be solved by the present disclosure is to provide a labeling method for an uttered voice, capable of providing a user interface that corrects named entities extracted through STT from a customer's utterance in the event of an error and provides information on the accurate named entities, and an apparatus for implementing the same.

The technical problems of the present disclosure are not limited to the above-described problems, and other technical problems not mentioned will be clearly understood by those of ordinary skill in the art from the following description.

### Technical Solutions

To address the aforementioned technical problems, a labeling method for an uttered voice, performed by a computing system, comprises receiving a first uttered voice from a user terminal, acquiring a first uttered text by converting the first uttered voice into text, extracting a named entity included in the first uttered text by performing Named Entity Recognition (NER) on the first uttered text, acquiring, from a call agent terminal connected via a voice communication session with the user terminal, a second uttered voice including a pronunciation of a corrected named entity corresponding to the extracted named entity, and
labeling the corrected named entity in the second uttered voice.

In one embodiment, the labeling method may further comprise between the extracting of the named entity and the acquiring of the second uttered voice, displaying a consultation screen on the call agent terminal, the consultation screen indicating a real-time update of the first uttered text, wherein the consultation screen is characterized in that the named entity included in the first uttered text is highlighted.

In one embodiment, the extracting of the named entity may comprise determining whether text identical to the extracted named entity is included in reference information, and
the displaying of the consultation screen on the call agent terminal may comprise, in response to text identical to the extracted named entity being determined not to be included in the reference information, displaying a consultation screen in which an error indicator is shown adjacent to the named entity included in the first uttered text.

In one embodiment, the reference information may include information on a user of the user terminal, history information related to the user, and product information related to the named entity.

In one embodiment, the labeling method may further comprise between the extracting of the named entity and the acquiring of the second uttered voice, displaying a consultation screen on the call agent terminal, the consultation screen indicating a real-time update of the first uttered text, wherein the consultation screen includes a related information display area for the named entity included in the first uttered text.

In one embodiment, the related information display area may display at least one of information on the user of the user terminal, history information related to the user, and product information related to the named entity.

In one embodiment, the information on the user may include a corrected named entity corresponding to the named entity, the named entity and the corrected named entity are different texts, and the related information display area is characterized in that the corrected named entity is highlighted.

In one embodiment, the history information related to the user may include chronological information of a task history related to the user, the task history includes a summary text for each task target, the summary text includes the corrected named entity corresponding to the named entity, the named entity and the corrected named entity are different texts, and the related information display area is characterized in that the corrected named entity is highlighted.

In one embodiment, the product information related to the named entity may be information on a product or service in which the corrected named entity corresponding to the named entity is included in a product name, service name, or detail information, the named entity and the corrected named entity are different texts, and the related information display area is characterized in that the corrected named entity is highlighted.

In one embodiment, the extracting of the named entity may comprise determining an intent of the first uttered text by inputting the first uttered text into a Natural Language Understanding (NLU) algorithm; extracting a plurality of named entities included in the first uttered text by performing named entity recognition on the first uttered text; determining a required-type named entity from among the plurality of named entities extracted from the first uttered text with reference to an order pattern of required-type and optional-type named entities corresponding to the determined intent; and determining the required-type named entity as the extracted named entity.

In one embodiment, the acquiring of the second uttered voice may comprise receiving, from the user terminal, a third uttered voice that is a response to the second uttered voice; acquiring a third uttered text by converting the third uttered voice into text; determining whether the third uttered text is positive feedback on the second uttered voice; and in response to the third uttered text being determined to be positive feedback on the second uttered voice, labeling the corrected named entity in the first uttered voice.

In one embodiment, the labeling method may further comprise constructing a training dataset including training data composed of the second uttered voice labeled with the extracted named entity, and training a first domain-specific Speech-to-Text (STT) model using the training dataset, wherein the first domain-specific STT model is an STT model specialized for a first domain assigned to a client company corresponding to the call agent terminal and the voice communication session.

In one embodiment, the extracting of the named entity may comprise determining an intent of the first uttered text by inputting the first uttered text into an NLU algorithm, constructing a training dataset including training data composed of the second uttered voice labeled with the extracted named entity, wherein the training data is labeled with a named entity extracted from the first uttered text having the first intent; and training a first domain-specific STT model using the training dataset, and the first domain-specific STT model is an STT model specialized for a first domain assigned to the first intent.

In one embodiment, the extracting of the named entity may comprise identifying a dialog model of a conversation through the voice communication session by inputting, into an NLU algorithm, the first uttered text and a plurality of uttered texts preceding the first uttered text; constructing a training dataset including training data composed of the second uttered voice labeled with the extracted named entity, wherein the training data is labeled with a named entity extracted from the first uttered text corresponding to a first node of a dialog flow according to the identified dialog model; and training a first domain-specific STT model using the training dataset, and the first domain-specific STT model is an STT model specialized for a first domain assigned to the first node.

To address the aforementioned technical problems, a labeling method for an uttered voice, performed by a computing system, comprises: receiving a first uttered voice from a user terminal, acquiring a (1-1)-th uttered text by converting the first uttered voice into text using a general-purpose Speech-to-Text (STT) model, acquiring a (1-2)-th uttered text by converting the first uttered voice into text using a domain-specific STT model, extracting a named entity included in the (1-1)-th uttered text by performing Named Entity Recognition (NER) on the (1-1)-th uttered text, extracting, as a corrected named entity, a named entity included in the (1-2)-th uttered text at a location corresponding to the extracted named entity, and transmitting, via a voice communication session with the user terminal, a named entity confirmation uttered voice including a pronunciation of the corrected named entity.

To address the aforementioned technical problems, a computing system comprises at least one processor, a communication interface configured to communicate with an external device, a memory configured to load a computer program executed by the processor, and a storage configured to store the computer program, wherein the computer program includes instructions for performing operations of: receiving a first uttered voice from a user terminal; acquiring a first uttered text by converting the first uttered voice into text, extracting a named entity included in the first uttered text by performing Named Entity Recognition (NER) on the first uttered text, acquiring, from a call agent terminal connected via a voice communication session with the user terminal, a second uttered voice including a pronunciation of a corrected named entity corresponding to the extracted named entity, and labeling the corrected named entity in the second uttered voice.

In one embodiment, the computing system may further include instructions for performing an operation of displaying a consultation screen on the call agent terminal, the consultation screen indicating a real-time update of the first uttered text, between the extracting of the named entity and the acquiring of the second uttered voice, the consultation screen is characterized in that the named entity included in the first uttered text is highlighted.

In one embodiment, the extracting of the named entity may comprise determining whether text identical to the extracted named entity is included in reference information, and the displaying of the consultation screen on the call agent terminal comprises, in response to text identical to the extracted named entity being determined not to be included in the reference information, displaying a consultation screen in which an error indicator is shown adjacent to the named entity included in the first uttered text.

In one embodiment, the reference information may include information on a user of the user terminal, history information related to the user, and product information related to the named entity.

In one embodiment, the computing system may further include instructions for performing an operation of displaying a consultation screen on the call agent terminal, the consultation screen indicating a real-time update of the first uttered text, between the extracting of the named entity and the acquiring of the second uttered voice, and the consultation screen may further include a related information display area for the named entity included in the first uttered text.

### BRIEF DESCRIPTION OF DRAWINGS

FIG. 1 illustrates the configuration of a system for performing labeling of uttered voice according to an embodiment of the present disclosure.

FIG. 2 is a block diagram illustrating detailed configurations of a computing device and a database for performing labeling of uttered voice according to an embodiment of the present disclosure.

FIG. 3 is a flowchart for explaining a labeling method for an uttered voice, performed by a computing system, according to one embodiment of the present disclosure.

FIG. 4 illustrates steps that are additionally performed in addition to the steps depicted in FIG. 2.

FIG. 5 illustrates a flow for explaining a detailed process of some of the steps depicted in FIG. 3.

FIG. 6 illustrates steps that are additionally performed in addition to the steps depicted in FIG. 2.

FIG. 7 is a flowchart for explaining a labeling method for an uttered voice, performed by a computing system, according to another embodiment of the present disclosure.

FIG. 8 is a flowchart for explaining a labeling method for an uttered voice, performed by a computing system, according to yet another embodiment of the present disclosure.

FIG. 9 is a flowchart for explaining a labeling method for an uttered voice, performed by a computing system, according to yet another embodiment of the present disclosure.

FIG. 10 illustrates an exemplary consultation screen in which named entities extracted by converting uttered voice into text according to some embodiments of the present disclosure are highlighted.

FIG. 11 illustrates an exemplary consultation screen displaying information related to named entities extracted by converting uttered voice into text according to some embodiments of the present disclosure.

FIG. 12 illustrates an exemplary consultation screen in which, when a named entity extracted according to some embodiments of the present disclosure contains an error, a corrected named entity corresponding to the original named entity is highlighted.

FIG. 13 illustrates an exemplary consultation screen in which, among multiple named entities extracted by converting uttered voice into text according to some embodiments of the present disclosure, a required-type named entity corresponding to the intent of the text is determined.

FIG. 14 illustrates an exemplary process for modifying and confirming a named entity by an AI callbot according to some embodiments of the present disclosure.

FIG. 15 is a diagram illustrating an exemplary hardware configuration of a computing system capable of implementing methods according to embodiments of the present disclosure.

### BEST MODES FOR CARRYING OUT THE INVENTION

Preferred embodiments of the present disclosure will hereinafter be described in detail with reference to the accompanying drawings. The advantages and features of the present disclosure, and the methods for achieving them, will become apparent with reference to the embodiments described below in detail together with the accompanying drawings. However, the technical scope of the present disclosure is not limited to the following embodiments but can be implemented in various forms. The following embodiments are provided merely to fully describe the technical scope of the present disclosure and to fully inform those skilled in the art to which the present disclosure pertains of its scope. The technical scope of the present disclosure is defined only by the claims.

When adding reference numerals to components in each drawing, it should be noted that, where possible, the same numerals are used for the same components, even if they are depicted in different drawings. Furthermore, in describing the present disclosure, detailed explanations of related known configurations or functions may be omitted if it is determined that such details could obscure the gist of the present disclosure.

Unless otherwise defined, all terms (including technical and scientific terms) used herein can be interpreted as having meanings commonly understood by those skilled in the art to which the present disclosure pertains. Terms generally defined in dictionaries are not ideally or excessively interpreted unless explicitly defined otherwise. The terms used herein are intended to describe the embodiments and are not intended to limit the present disclosure. Singular terms used herein include plural forms unless specifically stated otherwise.

Additionally, in describing the components of the present disclosure, terms such as first, second, A, B, (a), (b), and the like may be used. These terms are used merely to distinguish one component from another and do not limit the nature, sequence, or order of the components. When a component is described as being “connected,” “coupled,” or “linked” to another component, it should be understood that the component may be directly connected or linked to the other component, or another component may be “connected,” “coupled,” or “linked” between them.

The terms “comprises” and/or “comprising” as used in this specification do not exclude the presence or addition of one or more other components, steps, actions, and/or elements in addition to the stated components, steps, actions, and/or elements.

Some embodiments of the present disclosure will hereinafter be described in detail with reference to the accompanying drawings.

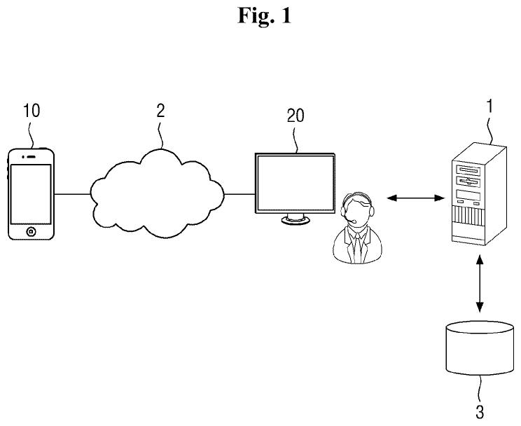

FIG. 1 illustrates the configuration of a system for performing labeling of uttered voice according to an embodiment of the present disclosure. Referring to FIG. 1, the system according to an embodiment of the present disclosure includes a computing device 1, a user terminal 10, a call agent terminal 20, and a database 3. The computing device 1 is connected to the call agent terminal 20 via a network, and the call agent terminal 20 is connected to the user terminal 10 via a telephone network, the Internet, or a carrier communication network, or the like.

The computing device 1 may be a server device that performs text conversion of a customer's utterance transmitted in real time via a customer center or call center within an enterprise using real-time Speech-to-Text (STT), context recognition using Natural Language Understanding (NLU), and data labeling through Text Analysis (TA). In addition, the computing device 1 may include an engine that provides Customer Relationship Management (CRM) services using customer information, consultation history information, product information, marketing information, and the like related to the customer.

The database 3 may be a device that stores customer information, consultation history information, and product information used by the computing device 1, as well as text data and labeling data generated by the computing device 1 through real-time STT processing.

The user terminal 10, which is a terminal of a customer who uses a customer center or call center service of an enterprise via telephone, video call, or Internet phone, may be one of a mobile computing device such as a smartphone, tablet PC, laptop PC, PDA, and the like, and a stationary computing device such as a personal desktop PC.

The call agent terminal 20, which is a terminal of a call agent who provides consultation services to customers through telephone, video call, or Internet phone at a customer center or call center of an enterprise, is connected to the user terminal 10 via a voice communication session. The call agent terminal 20 may be one of a mobile computing device such as a tablet PC or laptop PC, and a stationary computing device such as a personal desktop PC.

The computing device 1 receives the customer's uttered voice transmitted from the user terminal 10 during a consultation call between the user terminal 10 and the call agent terminal 20. The computing device 1 converts the customer's uttered voice into text in real time using STT, and extracts at least one named entity from uttered text obtained through the text conversion.

If the customer's uttered voice includes mispronunciation or incorrect information, an error may occur in the named entity extraction using STT. The computing device 1 may automatically detect such an error during the named entity extraction process using STT by referring to the customer information, consultation history information, and product information stored in the database 3. In this case, the computing device 1 may make the error in the named entity visually identifiable on the screen of the call agent terminal 20 so that the call agent may immediately recognize it.

In this case, the call agent checks the error displayed on the screen of the call agent terminal 20, then utters the corrected named entity with accurate pronunciation to obtain confirmation from the customer, and the computing device 1 may obtain a corrected uttered voice including the pronunciation of the corrected named entity from the call agent terminal 20.

The computing device 1 labels the corrected named entity in the corrected uttered voice obtained through the above process, and such labeled data is used as training data for training a real-time STT model.

According to the configuration of the system of the present disclosure as described above, in providing a real-time STT service for a consultation call between a customer and a call agent, labeling of training data for supervised learning of an STT model may be automatically performed from the customer's utterance.

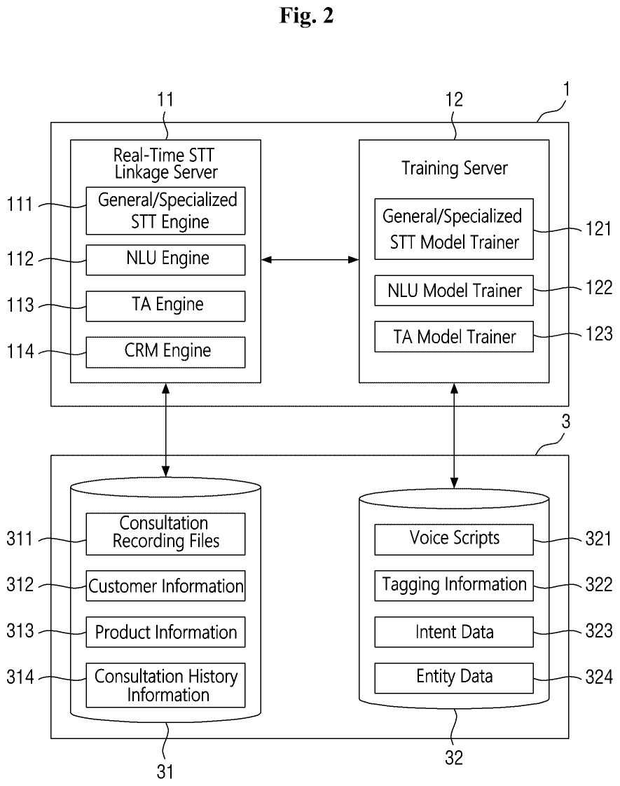

FIG. 2 is a block diagram illustrating detailed configurations of a computing device and a database for performing labeling of uttered voice according to an embodiment of the present disclosure. Specifically, FIG. 2 illustrates the detailed configurations of the computing device 1 and the database 3, among the components of the system according to the embodiment of the present disclosure, described in FIG. 1.

The computing device 1 may include a real-time STT linkage server 11 and a training server 12. The real-time STT linkage server 11 may include a general/specialized STT engine 111, an NLU engine 112, a TA engine 113, and a CRM engine 114, and the training server 12 may include a general/specialized STT model trainer 121, an NLU model trainer 122, and a TA model trainer 123.

The database 3 includes a first DB 31 for storing consultation recording files 311, customer information 312, product information 313, and consultation history information 314, and a second DB 32 for storing voice scripts 321, tagging information 322, intent data 323, and entity data 324.

The general/specialized STT engine 111 performs text conversion in real time for customer utterances transmitted via a customer center or call center. At this time, the general/specialized STT engine 111 may perform text conversion using at least one of a general STT model and a specialized STT model. Accordingly, uttered text obtained through the text conversion may be stored in the voice script information 321 of the second DB 32.

The NLU engine 112 inputs uttered text obtained from a customer's utterance by the general/specialized STT engine 111 through text conversion to an NLU model, extracts named entities from the uttered text, and determines the intent of the uttered text. Accordingly, information on the extracted named entities and determined intents through the NLU engine 112 may be stored in the entity data 324 and intent data 323, respectively, of the second DB 32. The NLU engine 112 may also perform an operation of identifying a dialog model through analysis of the uttered text.

The TA engine 113 may identify whether a named entity extracted through the general/specialized STT engine 111 and the NLU engine 112 is included in at least one of customer information 312, product information 313, and consultation history information 314 stored in the first DB 31. If the extracted named entity is determined to be included in at least one of the customer information 312, product information 313, and consultation history information 314, the TA engine 113 determines that there is no error in the extracted named entity, and performs the operation of labeling the extracted named entity in the customer's utterance or in the call agent's utterance for verifying the customer's utterance.

In addition, if the extracted named entity is determined not to be included in at least one of the customer information 312, product information 313, and consultation history information 314, the TA engine 113 determines that the extracted named entity contains an error, and obtains a corrected named entity for the extracted named entity from the call agent's utterance or from the information stored in the first DB 31. At this time, the TA engine 113 performs the operation of labeling the corrected named entity in the call agent's utterance or the customer's utterance. The corrected named entity may also be obtained from information displayed on the screen of the call agent terminal 20.

Accordingly, the data labeled through the TA engine 113 may be stored in the tagging information 322 of the second DB 32.

The CRM engine 114 performs the operation of providing CRM services to the customer of the user terminal 10 using the customer information 312, consultation history information 314, and product information 313 stored in the first DB 31, as well as marketing information generated based on such information. The CRM services may include consultation services for existing customers, A/S services, and marketing services for acquiring new customers and promoting product sales.

The general/specialized STT model trainer 121, NLU model trainer 122, and TA model trainer 123 included in the training server 12 perform training of STT, NLU, and TA models using training data including the entity data 324, tagging information 322, and intent data 323 generated by the real-time STT linkage server 11 and stored in the second DB 32, and perform the operation of generating or updating each model based on the training results.

According to the detailed configurations of the computing device 1 and the database 3 as described above, in providing a real-time STT service, a large amount of high-quality training data for training STT models specialized by field may be secured by automatically labeling named entities extracted from customer utterances. In addition, the accuracy of an STT model may be improved by training the STT model using training data obtained through automatic labeling.

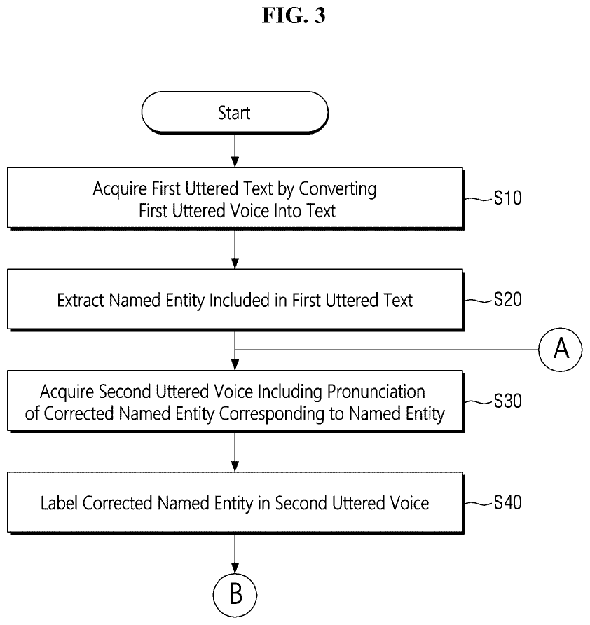

FIG. 3 is a flowchart for explaining a labeling method for an uttered voice, performed by a computing system, according to an embodiment of the present disclosure.

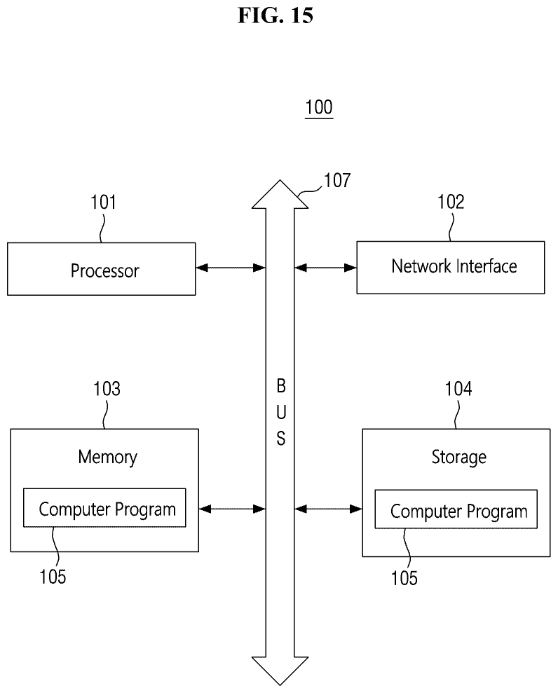

The labeling method for an uttered voice according to an embodiment of the present disclosure may be executed by the computing device 1 illustrated in FIG. 1. The computing device 1 that executes the method according to this embodiment may correspond to a computing system 100 illustrated in FIG. 15. The computing device 1 may be a device such as a PC or server that performs computation functions and application development functions.

The descriptions of each subject that performs certain operations or steps included in methods according to embodiments of the present disclosure may be omitted, and in such cases, the subject is understood to be the computing device 1.

According to the embodiment of the present disclosure to be described below, the function of automatically performing labeling of training data for supervised learning of an STT model from a customer's utterance may be provided.

First, in step S10, the computing device 1 receives a first uttered voice from the user terminal 10, and acquires a first uttered text by converting the received uttered voice into text in real time using STT.

Thereafter, in step S20, the computing device 1 extracts a named entity included in the first uttered text by performing Named Entity Recognition (NER) on the first uttered text.

In one embodiment, step S20 may include the step of determining whether any text identical to the extracted named entity is included in reference information. Here, the reference information may include information on users of user terminals, history information related to the users, and product information related to named entities.

In one embodiment, between step S20 and subsequent step S30, the computing device 1 may additionally perform the step of displaying a consultation screen on the call agent terminal 20, showing a real-time update of the first uttered text.

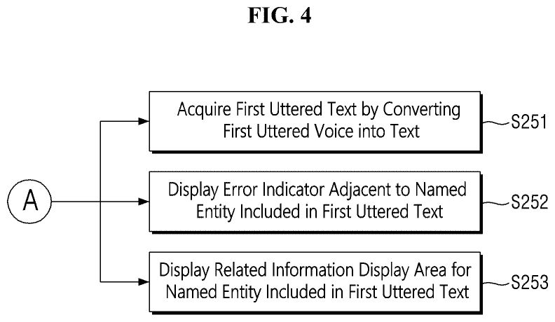

For example, as illustrated in FIG. 4, in displaying the consultation screen, at least one of steps S251, S252, and S253 may be performed.

In step S251, the computing device 1 may highlight the named entity included in the first uttered text on the consultation screen.

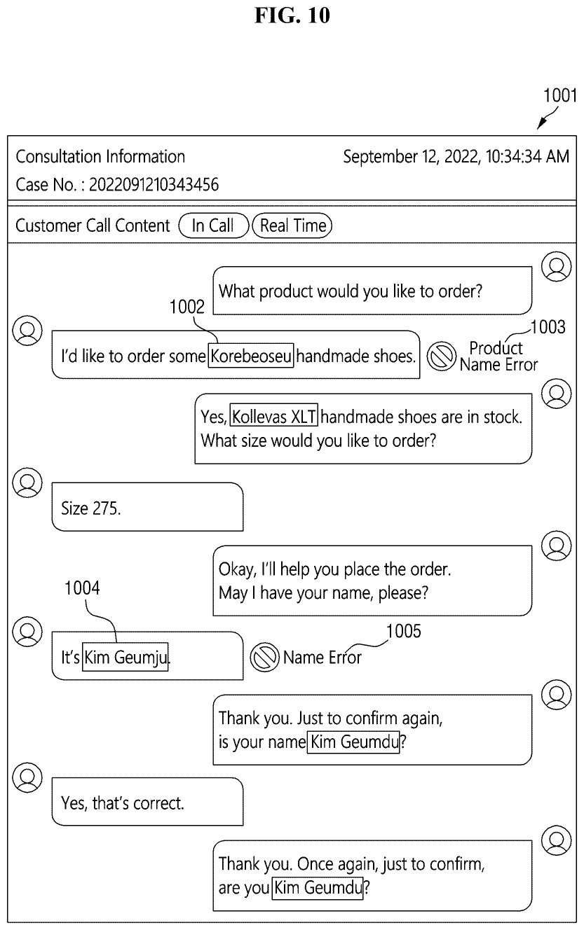

Referring to the example of FIG. 10, on a consultation screen 1001, uttered texts converted from the customer's uttered voice and the call agent's uttered voice through real-time STT may be displayed in real time, and named entities extracted from the uttered texts through an NER algorithm, i.e., “Korebeoseu” 1002 and “Kim Geumju” 1004, may be highlighted using box lines or boldface.

Also, in step S252, in response to the extracted named entity being determined not to be included in the reference information, the computing device 1 may display an error indicator adjacent to the named entity included in the first uttered text on the consultation screen.

In the example of FIG. 10, if “Korebeoseu” 1002, an extracted named entity from the customer's uttered voice, is not included in the product information 313 or consultation history information 314 stored in the first DB 31, an error indicator 1003 including the text “Product Name Error” may be displayed. Additionally, if “Kim Geumju” 1004, another extracted named entity, is not included in the customer information 312 stored in the first DB 31, an error indicator 1005 including the text “Name Error” may be displayed.

Furthermore, in step S253, the computing device 1 may display a related information display area for the named entity included in the first uttered text on the consultation screen.

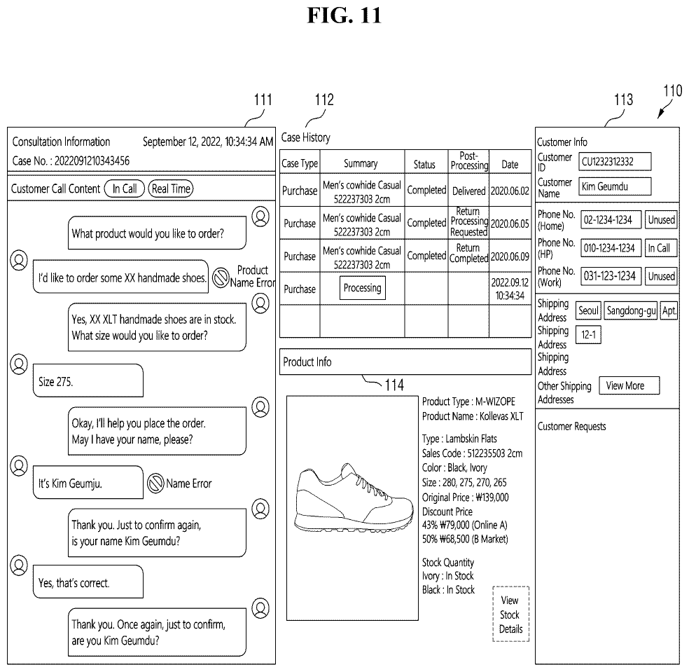

Referring to the example of FIG. 11, a related information display area (112, 113, and 114) may be displayed on a consultation screen 110, together with a real-time call history area 111 that shows uttered texts converted from the customer's consultation call in real time through STT. Specifically, the related information display area may include a first area 113 displaying customer information corresponding to “Kim Geumju” 1004, an extracted named entity from the customer's uttered voice during a consultation call, a second area 112 displaying previous consultation history information corresponding to “Kim Geumju” 1004, and a third area 114 displaying product-related information corresponding to “Korebeoseu” 1002, the other extracted named entity.

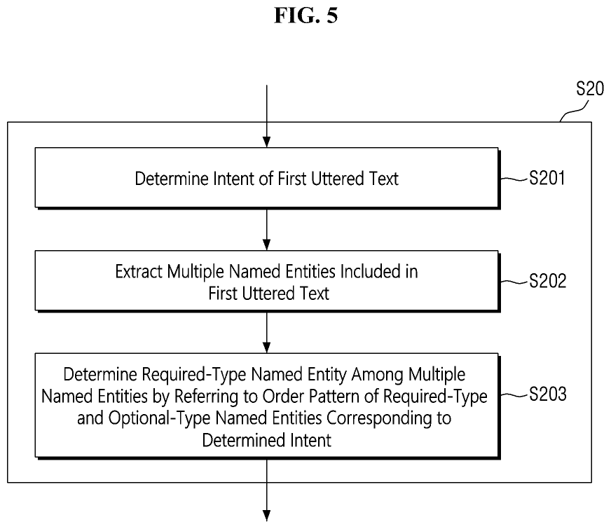

In one embodiment, as illustrated in FIG. 5, step S20 may include step S201, which is the step of determining the intent of the first uttered text by inputting the first uttered text into an NLU algorithm, step S202, which is the step of extracting multiple named entities included in the first uttered text by performing entity recognition, and step S203, which is the step of determining a required-type named entity among the extracted multiple named entities and selecting the determined named entity as a final extracted named entity.

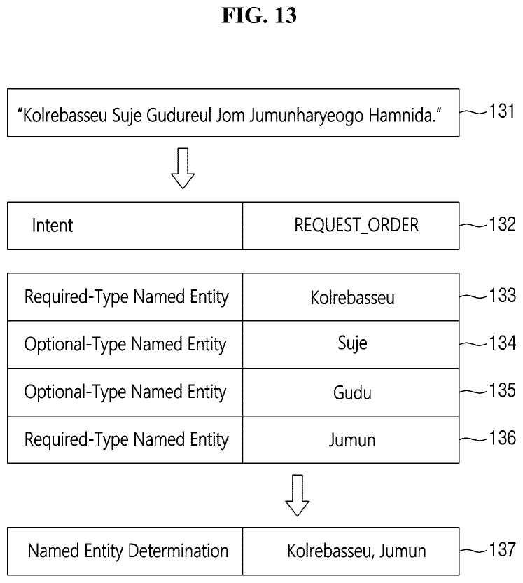

For example, referring to the example of FIG. 13, the computing device 1 may input the customer's uttered text, “Kolrebaseu Suje Gudu-reul Jom Jumunharyeogo Hamnida (I'd like to order Kollevas handmade shoes)” 131, into an NLU model and determine the intent of the uttered text as REQUEST_ORDER 132 based on the result output by the NLU algorithm. Here, the intent may be determined as one of various predefined intent types stored in advance that corresponds to the interpretation of the uttered text. For example, REQUEST_ORDER 132 may correspond to a case where the uttered text is interpreted as a request to order a product.

Additionally, the computing device 1 may extract multiple named entities such as “Kolrebaseu” (brand name) 133, “Suje” (handmade) 134, “Gudu” (shoes) 135, and “Jumun” (order) 136 from the customer's uttered text 131 using an NER algorithm.

In this case, the computing device 1 may classify each of the extracted multiple named entities as a required-type named entity or an optional-type named entity based on the determined intent, REQUEST_ORDER 132. For example, “Kolrebaseu” 133 and “Jumun” 136 may be determined as required-type named entities, and “Suje” 134 and “Gudu” 135 may be determined as optional-type named entities.

At this time, in determining required-type and optional-type named entities based on the intent, the computing device 1 may refer to the sequence pattern of each of the extracted multiple named entities. The sequence pattern may refer to the order of the multiple named entities within the sentence of the uttered text. Meanwhile, the computing device 1 may train the NLU model using training data in which the word order is varied, and may thus determine required-type and optional-type named entities corresponding to the intent even for different sentences having the same named entities in different orders.

Accordingly, in the example of FIG. 13, the computing device 1 may determine “Kolrebaseu” 133 and “Jumun” 136, which are the required-type named entities based on the intent, as named entities 137 to be labeled.

Thereafter, in step S30, the computing device 1 obtains a second uttered voice including the pronunciation of a corrected named entity for an extracted named entity from the call agent terminal 20 that is in a voice communication session with the user terminal 10. Here, the corrected named entity is a text different from the original named entity and may be most similar to the original named entity among the pieces of information stored in the database 3. For example, the corrected named entity may be a synonym or similar word to the original named entity.

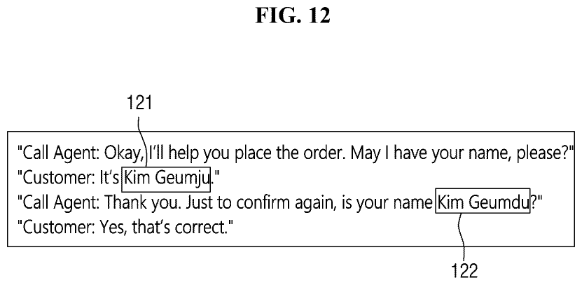

For example, in the example of FIG. 12, if among the extracted named entities from the customer's uttered voice, “Kim Geumju” 121, which corresponds to the name of the customer, is not included in the reference information stored in the first DB 31, a corrected named entity for “Kim Geumju” 121, i.e., “Kim Geumdu” 122, may be uttered by the call agent and displayed as text. The corrected named entity, “Kim Geumdu” 122, may be displayed in the call history area 111 of the consultation screen in FIG. 11. The corrected named entity, “Kim Geumdu”, may also be displayed in the first area 113 that shows customer information in the related information display area of FIG. 11. In this case, the corrected named entity may be highlighted in the form of a box line or in boldface so that the call agent can quickly identify it and confirm it with the customer. In one embodiment, the corrected named entity corresponding to the extracted named entity may be pre-registered and stored. For example, if the extracted named entity corresponding to the name of the customer, “Kim Geumju” 121, is not included in the customer information 312 of the first DB 31, the computing device 1 may identify a similar customer name, “Kim Geumdu,” through synonym search, determine the identified “Kim Geumdu” as a corrected named entity, and display it in the first area 113 of the related information display area of the consultation screen.

In one embodiment, if a named entity extracted from the customer's uttered voice is not included in the reference information stored in the first DB 31, a corrected named entity for the corresponding extracted named entity may be displayed in the second area 112 of the related information display area in FIG. 11, which shows the customer's consultation history information. In this case, the consultation history information of the customer includes chronological data of a task history related to the customer, and the task history may include a summary text for each task target. For example, the summary text may include a corrected named entity corresponding to the extracted named entity. Even in this case, the corrected named entity may be highlighted using a box line or boldface so that the call agent can quickly identify it in the second area 112 and confirm it with the customer.

In one embodiment, if a named entity extracted from the customer's uttered voice is not included in the reference information stored in the first DB 31, a corrected named entity for the corresponding extracted named entity may be displayed in the third area 114 of the related information display area in FIG. 11, which shows product information. In this case, the product information may include product names, service names, or product or service details. Even in this case, the corrected named entity may be highlighted using a box line or boldface so that the call agent can quickly identify it in the third area 114 and confirm it with the customer.

Accordingly, when an error is found in a named entity extracted through STT from the customer's utterance, a user interface capable of correcting the corresponding named entity and providing accurate named entity data may be provided.

Finally, in step S40, the computing device 1 labels the corrected named entity obtained through step S30 in the second uttered voice that includes the pronunciation of the corresponding corrected named entity. For example, as in the example of FIG. 12, if an error is found in the recognition of the extracted named entity “Kim Geumju” 121 from the customer's uttered text, the corrected named entity “Kim Geumdu” 122 for “Kim Geumju” 121 may be labeled in the call agent's second uttered voice that includes the pronunciation of the corresponding corrected named entity.

In one embodiment, the computing device 1 may receive a third uttered voice, which is a response from the user terminal 10 to the call agent's second uttered voice. The computing device 1 may obtain third uttered text by converting the third uttered voice into text, and determine whether the third uttered text is positive feedback on the second uttered voice. If it is determined that the third uttered text is positive feedback on the second uttered voice, the computing device 1 may label the corrected named entity in the customer's first uttered voice received from the user terminal 10, instead of the call agent's second uttered voice. For example, if the call agent seeks confirmation from the customer as to the second uttered voice, and the customer responds with positive feedback such as “Yes, that's correct,” the corrected named entity may be labeled in the customer's first uttered voice.

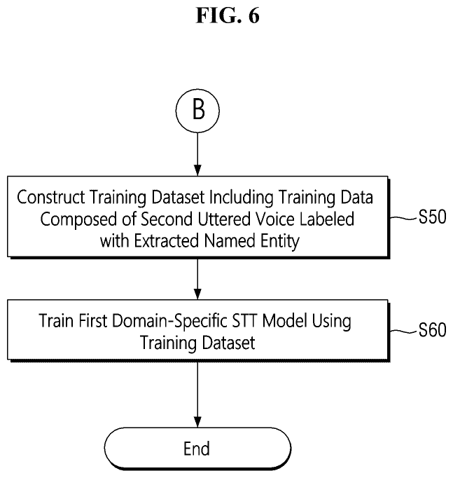

In one embodiment, as illustrated in FIG. 6, the computing device 1 may additionally perform steps S50 and S60 after performing steps S10 through S40 described with reference to FIG. 3.

In step S50, the computing device 1 constructs a training dataset including training data composed of second uttered voices with extracted named entities labeled therein.

Thereafter, in step S60, the computing device 1 performs machine learning of a first domain-specific STT model using the training dataset.

In one embodiment, the first domain-specific STT model may be a domain-specific STT model specialized for a first domain assigned to a client company corresponding to the call agent terminal 20 and the voice communication session pertain. For example, if the client company is an insurance company, an STT model trained on training data in which named entities commonly used in insurance companies are labeled may be used.

In another embodiment, the first domain-specific STT model may be a domain-specific STT model specialized for a first domain assigned to a first intent that is determined for the customer's first uttered text through an NLU algorithm. For example, if the domain corresponding to the first intent determined from the customer's uttered text is an address domain, an STT model trained on training data in which named entities extracted from utterances pertaining to customer addresses are labeled may be used.

For example, it is assumed that the domain-specific STT model is an address-specialized STT model. If among the named entities extracted from the customer's uttered voice, “Seoul-teukbyeolsi Guro-gu Gamrocheon-ro 12-gil, Iwoo Apateu 125-dong 128-ho” (Iwoo Apt. Bldg. 125-128, 12 Gamrocheon-ro, Guro-gu, Seoul) is not included in the reference information stored in the first DB 31, a second uttered voice including the pronunciation of a corrected named entity, “Seoul-teukbyeolsi Guro-gu Gamnocheol-ro 12-gil, Iyu Apateu 125-dong 128-ho” (Iyu Apt. Bldg. 125-128, 12 Gamnocheol-ro, Guro-gu, Seoul), may be obtained by the call agent, so that a training dataset composed of second uttered voices with labeled named entities may be constructed, and the address-specialized STT model may be trained.

If, as in conventional methods, addresses are recognized using only a general-purpose STT model trained on syllable units of proper nouns, the general-purpose STT model may be required to learn a large amount of data other than addresses. Thus, the recognition accuracy for utterances related to addresses may deteriorate, and overfitting may occur.

However, according to the present disclosure, by training an address-specialized STT model using a training dataset including second uttered voices in which named entities are labeled, not only syllables but also components of Korean addresses such as “˜ro” and “˜gil” may be learned to provide an STT model specialized for the address domain and to improve recognition accuracy in future utterances related to customer addresses.

In another embodiment, the first domain-specific STT model may be a domain-specific STT model assigned to a first node of a dialogue flow based on a dialogue model identified through an NLU algorithm for the customer's first uttered text. For example, by analyzing the customer's first uttered text and preceding utterances of the customer or the call agent to identify the dialogue model, and if the domain corresponding to the intent of the first node in the dialogue flow is an address, an STT model trained on training data in which named entities extracted from utterances related to customers' addresses are labeled may be used.

As described above, according to the method of the present embodiment, in providing a real-time STT service, by labeling named entities extracted from the customer's utterance, a large amount of high-quality training data for training a domain-specific STT model may be secured, thereby improving the accuracy of the STT model.

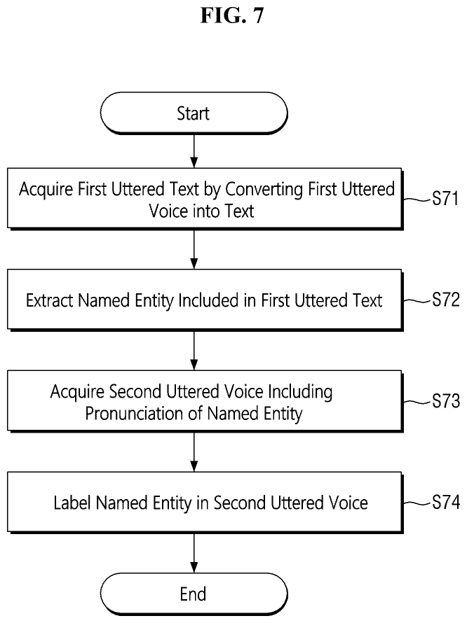

FIGS. 7 through 9 are flowcharts for explaining labeling methods for uttered voice, performed by a computing system, according to other embodiments of the present disclosure.

The labeling methods for uttered voice according to other embodiments of the present disclosure may be executed by the computing device 1 illustrated in FIG. 1. The computing device 1 for executing the methods according to the present embodiments may be the computing system 100 illustrated in FIG. 15.

The example illustrated in FIG. 7 corresponds to an embodiment where there is no error in an STT result for the customer's uttered voice, and performs steps S71 through S74.

First, in step S71, the computing device 1 receives a first uttered voice from the user terminal 10 and converts the first uttered voice into text, thereby acquiring a first uttered text.

Thereafter, in step S72, the computing device 1 performs NER on the first uttered text, thereby extracting a named entity included in the first uttered text.

In step S73, the computing device 1 acquires a second uttered voice including the pronunciation of the extracted named entity from the call agent terminal connected to the voice communication session with the user terminal.

Finally, in step S74, the computing device 1 labels the named entity in the call agent's second uttered voice.

According to the above embodiment, if there is no error in the named entity extracted from the customer's uttered voice during STT processing, the extracted named entity may be added to training data by being labeled in the uttered voice of the call agent who has pronounced the same pronunciation as that of the extracted named entity.

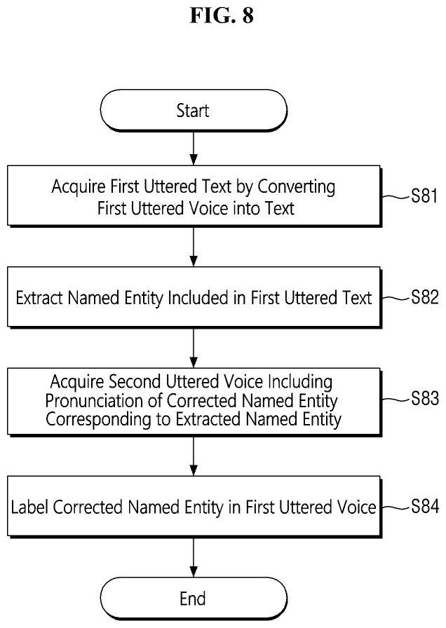

The example illustrated in FIG. 8 corresponds to an embodiment where there is an error in the STT result for the customer's uttered voice, and performs steps S81 through S84.

First, in step S81, the computing device 1 receives a first uttered voice from the user terminal 10 and converts the first uttered voice into text, thereby acquiring a first uttered text.

Thereafter, in step S82, the computing device 1 performs NER on the first uttered text, thereby extracting a named entity included in the first uttered text.

In step S83, the computing device 1 acquires a second uttered voice including the pronunciation of a corrected named entity for the extracted named entity from the call agent terminal 20 connected to the voice communication session with the user terminal 10.

Finally, in step S84, the computing device 1 labels the corrected named entity in the customer's first uttered voice.

According to the above embodiment, if there is an error in the named entity extracted from the customer's uttered voice during STT processing, the corrected named entity may be added to training data by being labeled in the customer's uttered voice.

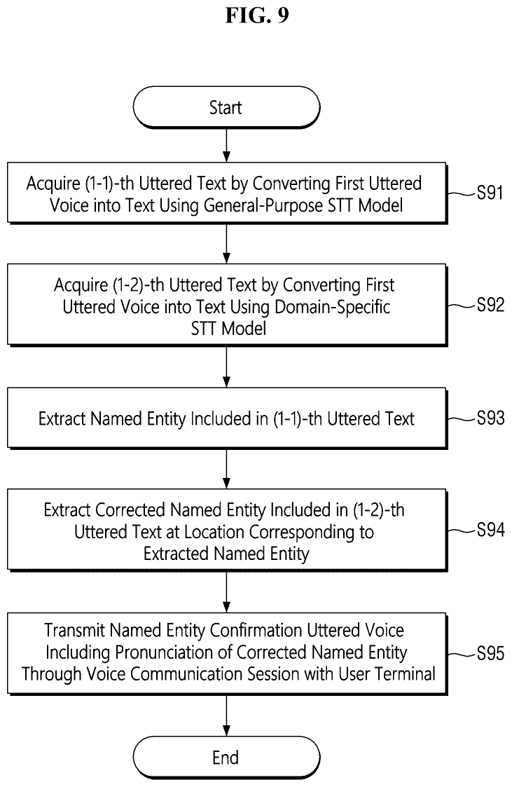

The example illustrated in FIG. 9 corresponds to an embodiment where, during a counseling session between the customer and an AI call agent (e.g., AI call bot), a named entity extracted through general-purpose STT differs from a named entity extracted through domain-specific STT, and confirmation of a corrected named entity is requested through the AI call agent's utterance, and performs steps S91 through S95.

First, in step S91, the computing device 1 receives a first uttered voice from the user terminal 10 and converts the first uttered voice into text using a general-purpose STT model, thereby acquiring a (1-1)-th uttered text.

In step S92, the computing device 1 converts the first uttered voice into text using a domain-specific STT model, thereby acquiring a (1-2)-th uttered text.

Thereafter, in step S93, the computing device 1 performs NER on the (1-1)-th uttered text, thereby extracting a named entity included in the (1-1)-th uttered text.

In step S94, the computing device 1 extracts a corrected named entity included at a position corresponding to the extracted named entity in the (1-2)-th uttered text.

Finally, in step S95, the computing device 1 transmits an uttered voice for customer confirmation, including the pronunciation of the corrected named entity, to the user terminal 10 through the voice communication session.

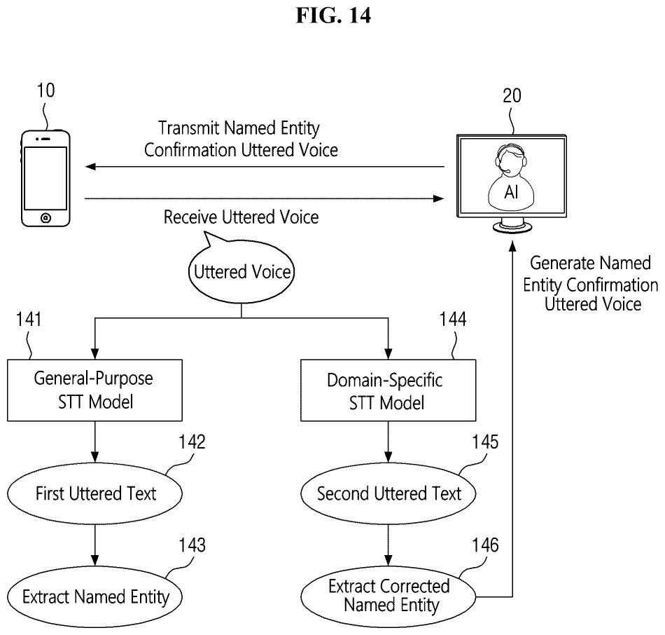

For example, referring to FIG. 14, during a consultation call between the customer of the user terminal 10 and the AI call agent of the call agent terminal 20, the computing device 1 may extract, from the customer's uttered voice received from the user terminal 10, a first uttered text 142 and a second uttered text 145 using a general-purpose STT model 141 and a domain-specific STT model, respectively.

In this case, if a named entity 143 extracted from the first uttered text 142 and a corrected named entity 146 extracted from the second uttered text 145 are different, the computing device 1 generates an uttered voice for customer confirmation, including the pronunciation of the corrected named entity 146, and provides the generated uttered voice to the call agent terminal 20.

Then, the AI call agent of the call agent terminal 20 delivers the uttered voice for customer confirmation, including the pronunciation of the corrected named entity 146, to the user terminal 10 through the voice communication session to request the customer of the user terminal 10 to confirm whether the corrected named entity 146 is correct.

According to the above embodiment, during an AI call bot-based consultation, if a named entity extracted through general-purpose STT and a named entity extracted through domain-specific STT differ, a request for confirmation of the corrected named entity extracted by the domain-specific STT may be sent to the customer through the AI call agent's utterance. Thus, if an error exists in the named entity extracted from the customer's uttered voice, the corrected named entity uttered by the AI call agent using the domain-specific STT may be used to improve the accuracy of named entity recognition.

As described above, according to the methods of the embodiments of the present disclosure, in providing a real-time STT service, labeling for training data for supervised learning of an STT model may be automatically performed based on customer utterances, and a large amount of high-quality training data for training a domain-specific STT model may be secured.

Additionally, even during a consultation using an AI call bot, if an error exists in the named entity extracted from a customer's utterance, information on a corrected named entity may be provided through STT specialized for the corresponding service domain.

FIG. 15 is a hardware configuration diagram of an exemplary computing system capable of implementing the methods according to some embodiments of the present invention.

As illustrated in FIG. 15, the computing system 100 may include at least one processor 101, a bus 107, a network interface 102, a memory 103 that loads a computer program 105 executed by the processor 101, and a storage 104 that stores the computer program 105. However, only components relevant to the embodiments of the present invention are illustrated in FIG. 15. Therefore, those skilled in the art will understand that additional general-purpose components may also be included beyond the components illustrated in FIG. 15.

The processor 101 controls the overall operation of the components of the computing system 100. The processor 101 may include at least one of a central processing unit (CPU), a micro processor unit (MPU), a micro controller unit (MCU), a graphics processing unit (GPU), or any other type of processor well known in the technical field of the present invention. Additionally, the processor 101 may perform computations for at least one application or program to execute the methods/operations according to various embodiments of the present invention. The computing system 100 may be equipped with one or more processors.

The memory 103 stores various data, commands, and/or information. To execute the methods/operations according to various embodiments of the present invention, the memory 103 may load one or more programs 105 from the storage 104. For example, when the computer program 105 is loaded into the memory 103, logic (or modules) may be implemented on the memory 103. An example of the memory 103 may be, but is not limited to a RAM.

The bus 107 provides communication functions between the components of the computing system 100. The bus 107 may be implemented in various forms such as an address bus, data bus, and control bus.

The network interface 102 supports wired and wireless internet communication for the computing system 100. The network interface 102 may also support various communication methods other than internet communication. For this purpose, the network interface 102 may include a communication module well known in the technical field of the present invention.

The storage 104 may non-transiently store one or more computer programs 105. The storage 104 may include a non-volatile memory such as a flash memory, hard disks, removable disk, or any other type of computer-readable recording medium well known in the technical field of the present invention.

The computer program 105 may include one or more instructions implementing the methods/operations according to various embodiments of the present invention. When the computer program 105 is loaded into the memory 103, the processor 101 may execute the instructions to perform the methods/operations according to various embodiments of the present invention.

In one embodiment, the computer program 105 may include instructions for performing the operations of: receiving a first uttered voice from a user terminal; acquiring a first uttered text by converting the first uttered voice into text; extracting a named entity included in the first uttered text by performing NER on the first uttered text; acquiring, from a call agent terminal connected to a voice communication session with the user terminal, a second uttered voice including the pronunciation of a corrected named entity for the extracted named entity; and labeling the corrected named entity in the second uttered voice.

In another embodiment, the computer program 105 may include instructions for performing the operations of: receiving a first uttered voice from a user terminal; acquiring a first uttered text by converting the first uttered voice into text; extracting a named entity included in the first uttered text by performing NER on the first uttered text; acquiring a second uttered voice including the pronunciation of the extracted named entity from a call agent terminal connected to a voice communication session with the user terminal; and labeling the named entity in the second uttered voice.

In yet another embodiment, the computer program 105 may include instructions for performing the operations of: receiving a first uttered voice from a user terminal; acquiring a first uttered text by converting the first uttered voice into text; extracting a named entity included in the first uttered text by performing NER on the first uttered text; acquiring a second uttered voice including the pronunciation of the extracted named entity from a call agent terminal connected to a voice communication session with the user terminal; and labeling the corrected named entity in the first uttered voice.

In still another embodiment, the computer program 105 may include instructions for performing the operations of: receiving a first uttered voice from the user terminal; converting the first uttered voice into a (1-1)-th uttered text using a general-purpose STT model; converting the first uttered voice into a (1-2)-th uttered text using a domain-specific STT model; extracting a named entity included in the (1-1)-th uttered text by performing NER on the (1-1)-th uttered text; extracting a corrected named entity included at a position corresponding to the extracted named entity in the (1-2)-th uttered text; and transmitting an uttered voice for customer confirmation, including the pronunciation of the corrected named entity, to the user terminal through a voice communication session.

Thus far, various embodiments of the present invention and their effects have been described with reference to FIGS. 1 through 15. The effects according to the technical scope of the present invention are not limited to the effects mentioned above, and other effects not mentioned may be clearly understood by those skilled in the art from the description below.

The technical scope of the present invention described thus far may be implemented as computer-readable code on a computer-readable medium. The computer-readable recording medium may be, for example, a removable recording medium (CD, DVD, Blu-ray disc, USB storage device, removable hard disk) or a fixed recording medium (ROM, RAM, hard disk built into a computer). The computer program recorded on the computer-readable recording medium may be transmitted over a network such as the internet to other computing devices, installed on the other computing devices, and used on those devices.

While all components constituting the embodiments of the present invention have been described as being combined or operating in combination, the technical scope of the present invention is not necessarily limited to such embodiments. That is, within the scope of the present invention, all components may be selectively combined and operate in various configurations.

Although operations are illustrated in the drawings in a specific sequence, it should not be understood that the operations must be performed in the illustrated order, sequentially, or that all operations must be performed to achieve desired results. In certain circumstances, multitasking and parallel processing may be advantageous. Furthermore, the separation of various configurations described in the embodiments above should not be understood as mandatory, and it should be understood that the described program components and systems may generally be integrated into a single software product or packaged as multiple software products.

Although the embodiments of the present invention have been described with reference to the attached drawings, those skilled in the art will understand that the present invention may be embodied in other specific forms without changing its technical scope or essential characteristics. Therefore, the embodiments described above should be understood as illustrative rather than limiting in every respect. The scope of protection of the present invention should be interpreted according to the appended claims, and all technical concepts within equivalent scope should be interpreted as being included in the technical scope defined by the present invention.

What is claimed is:

1. A labeling method for an uttered voice, performed by a computing system, the labeling method comprising:
receiving a first uttered voice from a user terminal;
acquiring a first uttered text by converting the first uttered voice into text;
extracting a named entity included in the first uttered text by performing Named Entity Recognition (NER) on the first uttered text;
acquiring, from a call agent terminal connected via a voice communication session with the user terminal, a second uttered voice including a pronunciation of a corrected named entity corresponding to the extracted named entity; and
labeling the corrected named entity in the second uttered voice.

2. The labeling method of claim 1, further comprising:
between the extracting of the named entity and the acquiring of the second uttered voice, displaying a consultation screen on the call agent terminal, the consultation screen indicating a real-time update of the first uttered text,
wherein the consultation screen is characterized in that the named entity included in the first uttered text is highlighted.

3. The labeling method of claim 2, wherein
the extracting of the named entity comprises determining whether text identical to the extracted named entity is included in reference information, and
the displaying of the consultation screen on the call agent terminal comprises, in response to text identical to the extracted named entity being determined not to be included in the reference information, displaying a consultation screen in which an error indicator is shown adjacent to the named entity included in the first uttered text.

4. The labeling method of claim 3, wherein the reference information includes information on a user of the user terminal, history information related to the user, and product information related to the named entity.

5. The labeling method of claim 1, further comprising:
between the extracting of the named entity and the acquiring of the second uttered voice, displaying a consultation screen on the call agent terminal, the consultation screen indicating a real-time update of the first uttered text,
wherein the consultation screen includes a related information display area for the named entity included in the first uttered text.

6. The labeling method of claim 5, wherein the related information display area displays at least one of information on the user of the user terminal, history information related to the user, and product information related to the named entity.

7. The labeling method of claim 6, wherein
the information on the user includes a corrected named entity corresponding to the named entity,
the named entity and the corrected named entity are different texts, and
the related information display area is characterized in that the corrected named entity is highlighted.

8. The labeling method of claim 6, wherein
the history information related to the user includes chronological information of a task history related to the user,
the task history includes a summary text for each task target,
the summary text includes the corrected named entity corresponding to the named entity,
the named entity and the corrected named entity are different texts, and
the related information display area is characterized in that the corrected named entity is highlighted.

9. The labeling method of claim 6, wherein
the product information related to the named entity is information on a product or service in which the corrected named entity corresponding to the named entity is included in a product name, service name, or detail information,
the named entity and the corrected named entity are different texts, and
the related information display area is characterized in that the corrected named entity is highlighted.

10. The labeling method of claim 5, wherein the extracting of the named entity comprises: determining an intent of the first uttered text by inputting the first uttered text into a Natural Language Understanding (NLU) algorithm; extracting a plurality of named entities included in the first uttered text by performing named entity recognition on the first uttered text; determining a required-type named entity from among the plurality of named entities extracted from the first uttered text with reference to an order pattern of required-type and optional-type named entities corresponding to the determined intent; and determining the required-type named entity as the extracted named entity.

11. The labeling method of claim 1, wherein the acquiring of the second uttered voice comprises: receiving, from the user terminal, a third uttered voice that is a response to the second uttered voice; acquiring a third uttered text by converting the third uttered voice into text; determining whether the third uttered text is positive feedback on the second uttered voice; and in response to the third uttered text being determined to be positive feedback on the second uttered voice, labeling the corrected named entity in the first uttered voice.

12. The method of claim 1, further comprising:
constructing a training dataset including training data composed of the second uttered voice labeled with the extracted named entity; and
training a first domain-specific Speech-to-Text (STT) model using the training dataset,
wherein the first domain-specific STT model is an STT model specialized for a first domain assigned to a client company corresponding to the call agent terminal and the voice communication session.

13. The labeling method of claim 1, wherein
the extracting of the named entity comprises: determining an intent of the first uttered text by inputting the first uttered text into an NLU algorithm; constructing a training dataset including training data composed of the second uttered voice labeled with the extracted named entity, wherein the training data is labeled with a named entity extracted from the first uttered text having the first intent; and training a first domain-specific STT model using the training dataset, and
the first domain-specific STT model is an STT model specialized for a first domain assigned to the first intent.

14. The labeling method of claim 1, wherein
the extracting of the named entity comprises: identifying a dialog model of a conversation through the voice communication session by inputting, into an NLU algorithm, the first uttered text and a plurality of uttered texts preceding the first uttered text; constructing a training dataset including training data composed of the second uttered voice labeled with the extracted named entity, wherein the training data is labeled with a named entity extracted from the first uttered text corresponding to a first node of a dialog flow according to the identified dialog model; and training a first domain-specific STT model using the training dataset, and
the first domain-specific STT model is an STT model specialized for a first domain assigned to the first node.

15. A labeling method for an uttered voice, performed by a computing system, the method comprising:
receiving a first uttered voice from a user terminal;
acquiring a (1-1)-th uttered text by converting the first uttered voice into text using a general-purpose Speech-to-Text (STT) model;
acquiring a (1-2)-th uttered text by converting the first uttered voice into text using a domain-specific STT model;
extracting a named entity included in the (1-1)-th uttered text by performing Named Entity Recognition (NER) on the (1-1)-th uttered text;
extracting, as a corrected named entity, a named entity included in the (1-2)-th uttered text at a location corresponding to the extracted named entity; and
transmitting, via a voice communication session with the user terminal, a named entity confirmation uttered voice including a pronunciation of the corrected named entity.

16. A computing system comprising:
at least one processor;
a communication interface configured to communicate with an external device;
a memory configured to load a computer program executed by the processor; and
a storage configured to store the computer program,
wherein the computer program includes instructions for performing operations of: receiving a first uttered voice from a user terminal; acquiring a first uttered text by converting the first uttered voice into text; extracting a named entity included in the first uttered text by performing Named Entity Recognition (NER) on the first uttered text; acquiring, from a call agent terminal connected via a voice communication session with the user terminal, a second uttered voice including a pronunciation of a corrected named entity corresponding to the extracted named entity; and labeling the corrected named entity in the second uttered voice.

17. The computing system of claim 16, wherein
the computing system further includes instructions for performing an operation of displaying a consultation screen on the call agent terminal, the consultation screen indicating a real-time update of the first uttered text, between the extracting of the named entity and the acquiring of the second uttered voice,
the consultation screen is characterized in that the named entity included in the first uttered text is highlighted.

18. The computing system of claim 17, wherein
the extracting of the named entity comprises determining whether text identical to the extracted named entity is included in reference information, and
the displaying of the consultation screen on the call agent terminal comprises, in response to text identical to the extracted named entity being determined not to be included in the reference information, displaying a consultation screen in which an error indicator is shown adjacent to the named entity included in the first uttered text.

19. The computing system of claim 18, wherein the reference information includes information on a user of the user terminal, history information related to the user, and product information related to the named entity.

20. The computing system of claim 16, wherein
the computing system further includes instructions for performing an operation of displaying a consultation screen on the call agent terminal, the consultation screen indicating a real-time update of the first uttered text, between the extracting of the named entity and the acquiring of the second uttered voice, and
the consultation screen further includes a related information display area for the named entity included in the first uttered text.
